(19) United States
(12) Patent Application Publication
(10) Pub. No.: US 2011/0311690 A1
(43) Pub. Date: Dec. 22, 2011

(54) System and method for the preparation of food in a cooking oven

(75) Inventor: Enrico Franzolin, Vigodarzere (PD) (IT)

(73) Assignee: UNOX s.p.A, Vigodarzere(PD) (IT)

(21) Appl. No.: 13/134,655

(22) Filed: Jun. 13, 2011

(30) Foreign Application Priority Data
Jun. 21, 2010 (IT) VI201OA000176

(51) Int. Cl. A23L 1/01; A21B 1/40

(52) U.S. Cl. 426/231; 126/21 A

(57) ABSTRACT

A system and a method for the preparation of food within a cooking oven (20), comprising means (22, 23, 24) for measuring one or more operating parameters of the oven (20) detected inside a cooking chamber (21), and sensor means (28), suitable to detect one or more values of at least one variable representing a cooking degree of the food product; in particular, during a cooking test of a predetermined type of food product, electronic control unit (29), programmed through a proper software, stores the values of the operating parameters of the oven (20) measured each time that the sensor means (28) detect a variation of the variable suitable to represent a cooking degree of the food product, in such a way that the electronic control unit (29) itself can control a plurality of conditioning systems (25, 26, 27) of the cooking chamber (21) of the oven (20), by means of signals corresponding to the values of the operating parameters stored for each valued of said variable suitable to represent the cooking degree of the food product, whenever a cooking process of that type of food product is selected.

The present invention generally refers to a system and a related method for the preparation of food in a cooking oven.

More specifically, the invention concerns a method and a system, so-called ACM or “Adaptive Clima”, which allow the user to store the cooking method actually occurred and repeat it over and over again with the certainty of an always identical outcome, even varying the amount of product inserted inside the oven.

From a theoretical point of view, the cooking of a food product qualifies as a non-stationary running heat exchange between the product to be cooked and the area (air and/or vapour) surrounding the product, wherein the initial temperature of the food product to be cooked is constant and almost uniform and at an initial reference time (corresponding to the beginning of the cooking or to the introduction of the cold food product into a preheated oven) the temperature of the air flowing around the food product is equal to a predetermined value corresponding to the temperature inside the cooking chamber of the oven.

It is known that for preparing food products inside cooking ovens of household type it is usually proceed depending on empirical parameters and time, temperature and possible variations of the same during cooking are established on the basis of tests or previous experiences, sometimes described in cook recipe books or similar publications.

Obviously this procedure does not allow to get an optimal cooking, due to the fact that the several variables involved cannot be completely controlled, and errors are always possible which are always unacceptable especially for cooking methods in ovens of professional type.

For the professional field ovens integrating prefixed cooking programs stored in specific electronic control appliances are also known.

The aforesaid cooking programs usually provide a given number of stages (the so-called cooking steps), for each of which the operator can set one or more desired parameters, such as, for example, the temperature and humidity inside the oven chamber and/or the speed of one or more fans with which the aforesaid chamber is equipped.

The duration of each phase is normally defined on the basis of certain predetermined times or, alternatively, on the basis of a value set for at least one cooking parameter (such as, for example, the temperature inside the food product to be cooked), which is compared with a corresponding value measured on the food product (for example, through a temperature sensor), in such a way that, when the measured value of the parameter reaches the corresponding set value, the cooking phase ends, regardless its time duration.

However, these cooking methods present a main drawback, which is determined by the lack of measurement repeatability when the load varies.

Indeed, if a proper cooking sequence for a particular type of product is experimentally found and, subsequently that sequence is repeated with the same product, but inserted in different quantities inside the oven, the cooking results are different compared to the initial tests.

Purpose of the present invention is, therefore, to overcome the drawbacks mentioned above and, in particular, to develop a system for the preparation of food in a cooking oven, which allows the user to store a cooking process actually occurred and to repeat it over and over again with the certainty of an always identical outcome even varying the amount of product inserted inside the oven.

Another purpose of the present invention is to create a system for the preparation of food in a cooking oven, which is highly safe and reliable, thus ensuring a perfect cooking of any food type and quantity.

Another purpose of the invention is to indicate a method for the preparation of food in a cooking oven, which can be implemented through the system mentioned above.

Further purpose of the present invention is to provide a system for the preparation of food in a cooking oven, which is highly reliable and efficient from the functional point of view and has extremely low operating costs, in the light of the benefits achieved. These and other purposes, according to the present invention, are achieved by a system for the preparation of food in a cooking oven according to the attached claim 1, and by a related method, according to the appended claim 7.

The dependent claims include other technical features of detail of the invention.

Advantageously, according to the method object of the present invention, the values measured experimentally during a test cooking constitute the set-point values of the following cooking and by varying the amount of product inserted inside the oven the cooking time will vary, but not the result of the cooking itself, since the product is cooked always in the same manner.

The system also optimizes the cooking time, since, if during the initial test cooking the duration of the various cooking stages, manually entered by the operator, is greater than necessary, when the process is automatically operated again, through an electronic control, the unnecessary times are definitely and completely eliminated.

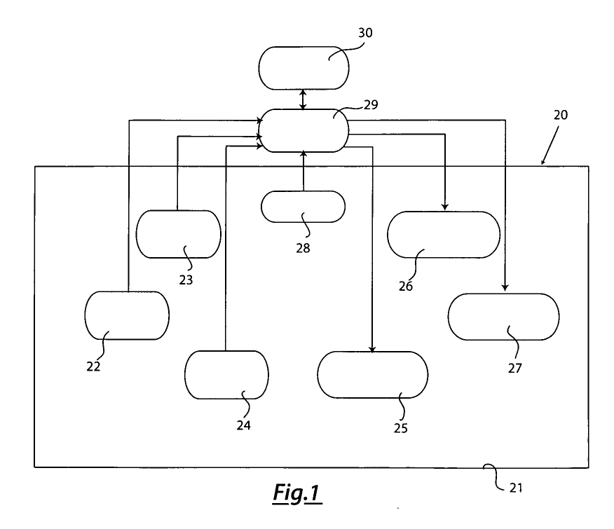

Further features and advantages of the current invention will be more evident from the description that follows, relating to an illustrative and preferred, but not limited to, embodiment of a system and a related method for the preparation of food products in a cooking oven, according to the present invention, and with reference to the attached drawing (FIG. 1), which shows a generic block diagram of the system for cooking food products object of the invention.

It has to be firstly noted that the cooking o degree f a food product may be represented by a characteristic parameter of the product itself and, in particular, such a cooking degree can be usually represented by the temperature measured inside of it, that is, at its thermal centre (so-called heart temperature).

The heart temperature, indeed, is one of the variables involved using the cooking method according to the present invention and can be directly or indirectly measured during the cooking process, through a proper sensor or probe inserted into the product to be cooked. Other physical quantities to be considered in order to implement the method according to the invention are the level of humidity and temperature inside the chamber of the oven and/or the ventilation speed in the chamber.

With particular reference to the mentioned FIG. 1, a cooking oven of substantially traditional type is schematically shown with 20, which includes a cooking chamber 21, delimited by walls and at least one sealing door and inside of which one or more fans, operated by appropriate drive motors 25, and one or more heating elements, connected with a control device allowing the user to vary the temperature inside the chamber 21 of the oven 20, are mounted.

A system for measuring temperature 22, a system for measuring humidity 23, a detection system 24 of the number of revolutions of the fan or fans, a conditioning system 26 of the inner humidity and a conditioning system 27 of the inner temperature, are provided inside the chamber 21 too.

A further temperature sensor 28 or heart probe is inserted into the food product placed inside the chamber 21 of the oven 20 and is suitable to continuously or discretely detect the heart temperature of the product, through the use of an appropriate sensor.

The temperature inside the product can also be measured by, beyond a heart probe 28 provided with only one temperature sensor, by a multi-point type probe, that is provided with several temperature sensors (usually equal to 4 or 5).

In this case, the probe 28 detects a heart temperature and a series of more peripherical temperatures, and the temperature value measured by one of the sensors of the probe or a combination of the values measured by the various sensors is used (for example, it is possible to choose a more external sensor, as faster and more reactive in the measure and, then, in sequence, other sensors more internal to the product, or it is possible to choose the sensor that measures the most different temperature from the set temperature of the chamber).

The system is also composed of an electronic control unit 29, connected with a user interface 30, to which the signals coming from the measuring systems 22 and 23, the detection system 24 and the heart probe 28 converge, and from which appropriate signals are sent to the motor 25 and the conditioning systems 26 and 27. In order to implement the method for the preparation of foods in the cooking oven 20, according to the invention, it is firstly necessary to perform a test cooking and, once got the desired cooking, it is possible to store it in the of the control unit 29, associating it with a given type of product (for example, chicken and/or roast potatoes), through a selection operation which can be made by means of the user interface 30.

Then, every time it is needed to cook that type of product, it is sufficient to quote, again through the user interface 30, the cooking process previously stored during the test cooking and, although the product quantity is changed compared to that one used during the test cooking, the control unit 29 is able to exactly reproduce the trend of the test cooking ensuring uniformity over time of the cooking results.

The operation of the system is, actually, based on the detection of the temperature inside the product (heart temperature), temperature and humidity values of the chamber 21 and number of revolutions of the fan or fans used in the chamber 21 of the oven 20.

In particular, when the test cooking is performed, it is necessary to insert the heart probe 28 into the product and, during such a test cooking, every time that probe 28 detects inside the product the change of units or fractions of a Celsius degree, stores some operating parameters of the oven 20 measured at that instant (typically, the temperature inside the cooking chamber 21, the percentage of humidity inside the cooking chamber 21 and the number of revolutions of the fan or fans).

When the test cooking has reached the end, the software of management of the control unit 29 of the oven 20 is able therefore to create and store a table showing the operating parameters of the oven 20 corresponding to each temperature value detected by the heart probe 28.

A possible table of the data which can be stored by the system during a test cooking with prefixed variations of 1° C. of the temperature that can be detected at the heart through the probe 28 is the following (it has to be noted that the position 1 of a fan is associated with a predefined speed interval substantially between 1,000 and 1,500 revolutions per minute (rpm), as well as the positions 2 and 3 are associated, respectively, with prefixed speed intervals substantially between 1,500 and 2,500 revolutions per minute (rpm) and between 2,500 and 2,800 revolutions per minute (rpm)):

| HEART | TEMPERATURE | HUMIDITY | |
|---|---|---|---|
| TEMPER- | INSIDE THE | INSIDE THE | |
| ATURE | OVEN CHAMBER | OVEN CHAMBER | FAN/FANS |
| (° C.) | (° C.) | (%) | POSITION |
| 25 | 121 | 60 | 2 |
| 26 | 123 | 50 | 2 |
| 27 | 128 | 50 | 1 |
| 28 | 131 | 60 | 1 |
| 29 | 134 | 40 | 3 |
| 30 | 137 | 40 | 3 |
| 31 | 140 | 30 | 1 |
| 32 | 143 | 30 | 2 |
| 33 | 147 | 30 | 3 |

Basically, whenever a cooking process is quoted, the control unit 29, on the basis of the table stored during the test cooking, reproduces, for each value of the heart temperature, the corresponding operating parameters of the oven 20, such as, as already reminded, the temperature and humidity of the chamber 21 and the fan speed (in which case it is possible to set a prefixed speed or to detect and control the number of revolutions of the fan).

In practice, the values of the parameters measured during the test area become the values of set-point is cooked, which are sent from the control unit 29 to air conditioning systems 26, 27 and the drive motor 25.

It is obvious that it is necessary that the heart probe 28 is inserted into the food, whenever a process of cooking which can be performed according to the method of the present invention is quoted, because the system must know the temperature inside product in order to reproduce the values of the parameters stored in the corresponding table.

In this way, by varying the quantity of product inserted into the chamber 21 of the oven 20, the cooking time will vary, but not the result of the cooking itself.

All things considered, that type of product is cooked always in the same manner, regardless its quantity and size.

The system object of the invention, finally, provides a further advantage, since it allows to optimize the cooking time.

Indeed, if, during the cooking test process, the duration of the various cooking stages, which can be manually inserted by the operator, may be longer than necessary, when the cooking process is automatically run again by the control unit 29, all the not needed time is completely and definitively eliminated.

Therefore, even if while cooking proceeds the actual trend of the temperature over time varies in comparison to an ideal average trend (due to the changing of the features of the food product, the conditions present in the cooking chamber 21 of the oven 20 or other boundary conditions), this does not constitute a limit for the method described according to the invention, since, by repeating the test cooking, at each new acquisition of a heart temperature value the other parameters of the cooking chamber 21 (temperature, humidity and ventilation) are automatically adjusted by the control unit 29 to the changed conditions of the current method.

Basically, the use of the cooking method according to the invention, being based on a limited number of detections made directly on the food product and inside the chamber 21 of the oven 20, allows to avoid the use of long and expensive testing on food products while cooking and does not even require the use of several measurements and/or ad hoc experimental diagrams.

The features of the system and the related method for the preparation of food in a cooking oven, which is the object of the present invention, as well as the advantages thereof, are clear from the description made.

It is, finally, clear that many other variations may be made to the preparation system and method in question, without departing from the principle of novelty intrinsic in the inventive idea expressed here, as it is clear that, in the practical implementation of the invention, materials, shapes and sizes of the illustrated details can be changed, as needed, and replaced with others technically equivalent.

1. System for the preparation of food within a cooking oven (20), comprising means (22, 23, 24) for measuring one or more operating parameters of the oven (20) inside a cooking chamber (21) and sensor means (28) for detecting one or more values of at least one variable representing a cooking degree of a food product, characterized in that, during a cooking test of a predetermined type of food product, a software programmed electronic control unit (29) stores the values of said operating parameters of the oven (20) which are measured each time that said sensor means (28) detect a variation of said at least one variable representing a cooking degree of the food product, and said electronic control unit (29) also controls a plurality of conditioning systems (25, 26, 27) of said cooking chamber (21), by means of signals corresponding to the values of said operating parameters of the oven (20) which are stored for each value of said at least one variable representing a cooking degree of the food product, whenever a cooking process of said type of food product is selected.

2. Cooking system as claim 1, characterized in that said means (22, 23, 24) detect values of temperature and humidity inside said cooking chamber (21).

3. Cooking system as claim 1, characterized in that said measuring means (22, 23, 24) set and/or control velocity or rotation values of at least one fan (24) which is placed inside said cooking chamber (21).

4. Cooking system as claim 1, characterized in that said sensor means (28) include at least one temperature probe, inserted inside the food product placed in the cooking chamber (21) of the oven (20) and able to measure a core temperature of the product.

5. Cooking system as claim 4, characterized in that said probe is a multi-point probe, with a plurality of temperature sensors which detect a core temperature and a plurality of values of peripheral temperatures and which use a temperature value measured by one of the sensors of said probe or a combination of temperature values measured by said sensors.

6. Cooking system as claim 1, characterized in that said electronic control unit (29) is connected with a user interface (30) for selecting parameters and/or variable by a user, which receives signals coming from said measuring means (22, 23, 24) and from said sensor means (28) and sends signals to at least one drive motor (25) of at least one fan of the oven (20) and to related conditioning systems (26, 27) of the temperature and humidity of the cooking chamber (21) of said oven (20).

7. Method for preparing food in a cooking oven (20) including at least the following steps:
implementation of a prefixed cooking test for every type of food product, during which sensor means (28) detect values of temperature inside the food product;
memorization of said cooking test associated with said type of food product,
selection of said memorized cooking test together with said type of food product every time said type of food product is cooked, even in different quantity than the quantity provided during said cooking test,
characterized in that, every time said sensor means (28) detect a temperature change in the food product of at least one fraction or units of 1 degree, one or more operating parameters of said oven (20), such as temperature and humidity of the cooking chamber (21) of said oven (20) and/or speed of at least one fan provided within said oven (20), are measured when said change occurs and said operating parameters are also stored in a data table at the end of said cooking test.

8. Cooking method as claim 7, characterized in that, following said selection of a memorized cooking test, said measured operating parameters of the oven (20) constitutes set-point values of related operating parameters for subsequent cooking.
